(19) United States
(12) Patent Application Publication
(10) Pub. No.: US 2026/0249802 A1
(43) Pub. Date: Aug. 27, 2026

(54) GAS GENERATOR

(71) Applicant: ZF AIRBAG GERMANY GMBH, Aschau a. Inn (DE)

(72) Inventor: Christian JUNG, Mühldorf am Inn (DE)

(21) Appl. No.: 18/714,359

(22) PCT Filed: Oct. 27, 2022
(86) PCT No.: PCT/EP2022/080042

§ 371 Date: May 29, 2024

(30) Foreign Application Priority Data
Nov. 30, 2021 (DE) 10 2021 131 411.9

(51) Int. Cl. B60R 21/017; B60R 21/0134; B60R 21/264; B60R 22/46

(52) U.S. Cl. CPC B60R 21/017; B60R 21/0134; B60R 21/264; B60R 22/4628

(57) ABSTRACT

The invention relates to a gas generator (10) comprising an activation device (26) which includes an energy converter (12), wherein the energy converter (12) is surrounded by a gas and is free from pyrotechnical materials, and wherein, when electric current is applied, the energy converter (12) is designed to convert electrical energy directly to thermal energy and to release the same, the released thermal energy suddenly heating and expanding the gas surrounding the energy converter (12). The gas generator (10) can be used in particular for a safety device in a vehicle. The invention further describes a safety device comprising the gas generator (10) and a method of triggering the safety device.

### TECHNICAL FIELD

The invention relates to a gas generator, specifically for a safety device in a vehicle. Gas generators are known and provide a filling gas, for example for filling an airbag or for driving a belt tensioner. Therefore, gas generators are an elementary part of vehicle safety systems.

### BACKGROUND

In known hybrid gas generators, the major part of the filling gas is generated from compressed gas stored in the housing of the gas generator. Usually, the housing is opened by activating a pyrotechnical propellant, wherein the stored compressed gas is heated by activating the pyrotechnical propellant and can flow out.

One configuration of hybrid gas generators is constituted by the so-called shockwave hybrid gas generators. This type of generators has a first membrane in the vicinity of a pyrotechnical propellant which seals a first opening of a pressure chamber, and a second membrane remote from the propellant which closes a second opening of the pressure chamber. The two membranes are usually arranged opposite each other. The activation of the pyrotechnical propellant causes both membranes to be destroyed. The sudden opening of the first membrane generates an abrupt pressure difference resulting in a shockwave running through the pressure chamber. The shockwave is sufficient to open the second membrane of the pressure chamber and to release the compressed gas stored in the pressure chamber. A gas generator of this type is known from DE 203 19 564 U1, for example.

The above-mentioned gas generators have in common that they require a pyrotechnical propellant to activate the gas generator. Upon activation, the pyrotechnical propellant converts a stored chemical energy to temperature, pressure and kinetic energy. The gas present inside the gas generator thus can be heated and expanded almost without delay. The rapid timing of this process is an elementary prerequisite for the operation of a gas generator in a vehicle safety system, for example as part of an airbag module.

Pyrotechnical propellants usually consist of chemical compounds which can be activated by the supply of energy. As a rule, the activation is performed by electrically contacting the chemical components of the pyrotechnical propellant, whereupon the components react in an exothermal (energy-releasing) reaction. The heat generated by the exothermal reaction is used to heat a cold gas in the gas generator. At the same time, the released energy can expand the pressurized cold gas stored in the pressure chamber. The expansion of the gas results in an increase in pressure inside the gas generator which can be used to release the gas.

However, the use of pyrotechnical propellants involves a number of drawbacks. One drawback of pyrotechnical propellants consists in the fact that activating a propellant is an irreversible process. Once activated, the chemical reaction therefore cannot be stopped any more, and thus the gas generator is used up. Consequently, those gas generators must be replaced. The replacement of gas generators involves additional costs.

On the other hand, unused gas generators including non-activated propellants must be handled with specific safety measures. This constitutes a drawback in particular when gas generators including non-activated propellants in vehicles are disassembled.

In addition, once an activation of a pyrotechnical propellant has been started, it is very difficult to control and can no longer be monitored in real time.

Consequently, efforts are made to find a replacement for pyrotechnical propellants in gas generators.

The scientific article by F. Schutt et al. (Materials Today, 2021, “Electrically powered repeatable air explosions using microtubular graphene assemblies”) describes a novel material that is capable of generating so-called “air explosions” by the supply of current. The material described in the article is made of crosslinked carbon nanotubes which form a macroscopic framework connection due to the crosslinking. The material is capable of absorbing supplied electrical energy and transferring it abruptly to a surrounding gas volume and to heat and expand the latter almost without delay, while the above-mentioned “air explosions” are generated.

### SUMMARY

The object underlying the invention is to provide a gas generator free from pyrotechnics. According to the invention, the object is achieved by providing a gas generator including an activation device according to claim 1.

Advantageous embodiments of the gas generator according to the invention including the activation device are stated in the subclaims which can be optionally combined with each other.

According to the invention, the gas generator comprises an activation device comprising an energy converter, wherein the energy converter is surrounded by a gas and is free from pyrotechnical materials, and wherein the energy converter is designed, when electric current is applied, to convert electrical energy directly to thermal energy and to release it, the released thermal energy suddenly heating and expanding the gas surrounding the energy converter. The gas generator can be used specifically for a safety device in a vehicle.

The invention is based on the fundamental idea to provide an activatable material for a gas generator which is free from pyrotechnics. In particular, the use of chemical reactions for operating a gas generator is intended to be avoided. For this purpose, the activation device includes a physical energy converter which is free from pyrotechnical materials. When electric current is applied to the energy converter, the latter is capable of converting the supplied electrical energy directly to thermal energy and releasing it. The gas surrounding the energy converter can be suddenly heated and expanded in this way.

The inventors found that the material described in the scientific study by F. Schütt et al. (Materials Today, 2021, “Electrically powered repeatable air explosions using microtubular graphene assemblies”) is suited as an energy converter in an activation device for gas generators free from pyrotechnics.

For the production of the energy converter, tetrahedrally shaped zinc oxide microparticles can be mixed with graphene oxide dissolved in water, the graphene oxide forming a thin layer on the tetrahedrally shaped zinc oxide microparticles. The zinc oxide nano particles serve as a framework pattern and are removed again by a subsequent washing step with hydrochloric acid. After that, the graphene oxide-based samples are chemically reduced, and the pores are activated by various washing steps. The resulting material has a network of carbon nanotubes, the carbon nanotubes being hollow. The individual carbon nanotubes have an average length from 1 um to 200 μm, specifically of about 25 μm, and a diameter from 0.2 μm to 20 μm, specifically of about 2 μm. The wall thickness ranges from 2 nm to 200 nm, preferably is about 25 nm. Thus, the energy converter can be described as crosslinked carbon nanotubes based on selectively partially oxidized graphene.

The energy converter material obtained in this way can repeatedly carry out physical explosions, so-called “air explosions”, by supplying electrical energy. A discrete explosion process comprises various steps, i.e., a heating step, an expansion step and a cooling step. Initially, by applying a current, the gas volume enclosed in the macro-porous structure of the energy converter is suddenly heated. After heating, the gas volume expands in a split second in the form of a physical explosion. The expansion of the gas volume subsequently results in cooling thereof. After that, the energy converter material is ready for a new cycle again.

Based on standard conditions, several cubic centimeters of gas volume in this way can be heated to several hundred degrees, namely over several hundreds of thousands of cycles. In this case, standard conditions are understood to be 1 bar and 273.15 K. In general, heating rates of more than 300 000 K s−1 and repetition rates of several hertz, based on 1 bar of pressure, can be reached.

In accordance with the invention, the term suddenly is considered to mean a heating period of less than 15 ms, preferably less than 10 ms, specifically preferred less than 5 ms.

“Free from pyrotechnics” means that the activation device is free from chemical compounds which in the case of intentional activation undergo an exothermal chemical reaction generating an explosive change of pressure and temperature.

The physical principle behind the application of the energy converter in the activation device free from pyrotechnics is known as the “First Joule's Law”. In simple terms, the law means that an electric current flowing in an electric conductor generates thermal energy. The effect is exploited in the present invention to suddenly heat and expand a gas surrounding the energy converter. In contrast to conventional pyrotechnical propellants known from prior art, the energy converter used here applies purely physical measures to heat and expand the gas. Therefore, resorting to irreversible chemical reactions can be avoided.

Since the energy converter is operated only by the use of electrical energy, the process of heating and expanding the gas volume is reversible. In other words, the energy converter and, resp., the activation device can be re-used after completed activation. Thus, a gas generator operated by said activation device is particularly sustainable.

At the same time, when the current supply is stopped, the energy converter and the activation device can be easily deactivated. In this way, it is easily possible to disassemble a gas generator provided with said activation device, for example in a vehicle.

In a preferred embodiment, the energy converter includes a highly open-porous structure having a porosity of >95% which is based on crosslinked carbon nanotubes, the carbon nanotubes being formed of graphene and/or partially oxidized graphene.

Preferably, the carbon nanotubes are hollow and have an average length of 1-200 μm, specifically about 25 μm, and a diameter of 0.2-20 μm, specifically 2 μm. The wall thickness on average amounts to 2-200 nm, specifically about 25 nm.

The open porosity of the network is above 95%.

Due to the macro-porous structure of crosslinked carbon nanotubes, the energy converter has a high surface-to-volume ratio. Due to this structural nature, the energy converter can interact with a large gas volume and, in this way, can transfer the thermal energy particularly efficiently to the surrounding gas. Since the carbon nanotubes present in the energy converter are hollow, they can receive the gas volume particularly efficiently, which in turn increases the surface interacting with the surrounding gas volume.

The carbon nanotubes can be made either of graphene and/or of partially oxidized graphene. Thus, the carbon nanotubes can be made of different graphene-containing materials. Moreover, a mixture of graphene and partially oxidized graphene can be provided. Consequently, the thermal and electrical properties of the carbon nanotubes made therefrom can be adjusted as required.

The energy converter can be manufactured by simple wet-chemical methods. The manufacture of carbon nanotubes is known, for example from F. Rasch et al., ACS Appl. Mater. Interfaces 11 (2019) 44652-44663 and F. Schütt, et al., Nat. Commun. 8; 1-10.

Preferably, the energy converter is a material from the scientific article by Schütt et al. (Materials Today, 2021, “Electrically powered repeatable air explosions using microtubular graphene assemblies”). The materials shown in the article are specifically suited for use as energy converter in the activation device mentioned in the beginning for the operation of a gas generator. In particular, the materials described there illustrate a good responding behavior to the supply of electrical energy and conversion thereof to thermal energy for the sudden expansion of a surrounding gas.

In one configuration of the invention, the energy converter meets at least one of the following properties:
a heating rate of at least 10⁵ K s⁻¹ for a gas or gas mixture at a pressure of 1 bar;
a volumetric thermal capacity ranging from 0.5 KJ m⁻³ K⁻¹ to 5 KJ m⁻³ K⁻¹;
a volumetric surface ranging from 0.01 m² cm⁻³ to 1 m²cm⁻³;
a density of less than 100 mg cm⁻³; and/or
a Knudsen number of «1.

An energy converter that meets at least one of the above-mentioned properties is particularly suited for converting electrical energy directly to thermal energy and generating a physical explosion.

A high heating rate of at least 105 K s−1 for a gas or gas mixture at a pressure of 1 bar allows the energy converter to suddenly heat up by the supply of electrical energy and to transfer the thermal energy accumulated in this way directly to the gas volume surrounding the energy converter.

Advantageously, the energy converter has an extremely low thermal capacity, specifically a thermal capacity comparable to that of air. The supplied electrical energy thus can be converted to thermal energy particularly efficiently and without losses.

High volumetric surfaces of the energy converter allow for a surface of particularly high interaction with the surrounding gas volumes.

Further, the energy converter has only a density of less than 100mg/cm³ , preferably a density ranging from 2 to 20 mg/cm³. The energy converter so-to-speak is an aero material of very low density. Due to its low density, the energy converter according to the invention can be used in many ways without having to be made available in large mass quantities.

Finally, the energy converter can have a Knudsen number of «1 to enable free diffusion of gas inside the macroporous structure. Preferably, the average free path of a gas molecule is smaller by two to three magnitudes than the pore size of the macroporous energy converter. Thus, the gas molecules can freely interact with one another without hitting the outer pore walls. As a consequence, an almost unhindered heat input into the gas volume surrounding the energy converter can take place.

In one embodiment, a capacitor connected to a power source is associated with the activation device, the capacitor including an electrical contact with the energy converter and being arranged to apply electric current to the energy converter.

Hence, the supply of electric current to the energy converter can be easily ensured. The electrical energy is stored on a capacitor and can be transferred to the energy converter as required.

In another configuration of the invention, the electric current takes the shape of a current pulse, wherein the duration, the current intensity and the voltage of the current pulse is adjustable.

Advantageously, an almost complete control over the actuation of the energy converter and, thus, the activation device of the gas generator is achieved. Thus, also the trigger behavior of the gas generator can be controlled substantially completely.

In particular, the current intensity and voltage supplied can be variably adjusted. Therefore, even the trigger behavior of the gas generator can be variably adjusted. If a particularly strong trigger behavior is desired, the voltage and current intensity supplied to the energy converter can be appropriately increased. Inversely, if a weak trigger behavior is desired, the voltage and current intensity supplied can be reduced.

Furthermore, the duration of the current pulse can help adjust also the duration of the heating process and the expanding process of the gas volume surrounding the energy converter. If the duration of the current pulse is increased, the surrounding gas, too, can be heated more strongly. Consequently, also the gas can expand more strongly. Depending on the situation, it is possible in this way to actuate the energy converter differently strongly according to requirements.

In one embodiment, the activation device is provided to be disposed inside a pressure chamber and the gas surrounding the energy converter is provided to be a compressed gas, the pressure chamber including an outflow opening closed by a pressure relief valve, wherein the pressure relief valve opens the outflow opening from a specific excess pressure inside the pressure chamber.

In this embodiment, the energy converter can heat and expand the surrounding gas or compressed gas by the input of electrical energy. Accordingly, excess pressure is formed inside the pressure chamber and finally results in the outflow opening being opened. The expanded gas volume then can escape via the pressure relief valve. The energy converter can be arranged and, resp., spread almost as desired inside the pressure chamber. What is decisive is the fact that a free expansion or circulation of the gas volume is possible inside the pressure chamber.

In another embodiment, the pressure relief valve is a bursting element.

The bursting element is configured so that it tears from a specific excess pressure inside the pressure chamber and releases the gas volume stored inside the pressure chamber. Advantageously, compared to a pressure relief valve, a bursting element enables the gas volume stored in the pressure chamber to be released even more quickly. The bursting element can be designed, for example, as a bursting disk or a bursting membrane.

In one configuration of the invention, a pressure chamber filled with compressed gas is provided with a first bursting element, the first bursting element closing a first opening of the pressure chamber, the pressure chamber including a second bursting element opposite to the first bursting element in the axial direction and closing a second opening of the pressure chamber, the activation device being arranged outside the pressure chamber and close to the first bursting element, and, when electric current is applied to the energy converter, the first bursting element being destroyed and a shockwave which is sufficient to open the second bursting element being formed.

This embodiment makes use of the principle of shockwave generator known from prior art. In contrast to prior art, in this embodiment the activation device free from pyrotechnics according to the invention is provided with the above-described energy converter, however. This allows for designing a shockwave gas generator without the necessity to install a pyrotechnical igniter.

As already described, the energy converter is activated only by applying an electric current. Therefore, the energy converter can form a shockwave inside the gas generator without activating a pyrotechnical propellant.

In an advantageous configuration of the invention, the activation device and the pressure chamber are interconnected via at least one compensation hole for pressure compensation.

Due to the pressure compensation hole, the same pressure is provided in the activation device and in the pressure chamber. Advantageously, the pressure compensation hole therefore enables pressure compensation inside the gas generator.

In addition, during assembly, the activation device can be filled with compressed gas through the compensation hole without the energy converter being damaged.

The energy converter can be designed as a pressure sensor for monitoring the gas pressure. To this end, inter alia the piezoresistive and/or piezoelectric properties of the energy converter can be used. For example, at certain time intervals a testing current can be applied to the energy converter, wherein a resistance is measured which, in turn, allows conclusions to be drawn about the pressure prevailing in the pressure chamber.

The energy converter therefore can monitor the fill level of the gas generator without any further pressure sensor having to be installed.

In one embodiment, the gas or gas mixture surrounding the energy converter comprises an inert gas, specifically argon or an argon-helium mixture or nitrogen even in combination with the afore-mentioned ones.

In an advantageous embodiment, the gas or gas mixture surrounding the energy converter comprises hydrogen and oxygen in a reactive mixture, optionally together with the above-described inert gas.

The energy converter is capable of converting the electric current directly to thermal energy. In this embodiment, the thermal energy can be used to initiate an exothermal reaction between hydrogen and oxygen. The amount of energy released by the exothermal reaction can be used to additionally heat the gas surrounding the energy converter and to increase the expansion thereof.

Inside the pressure chamber at least one energetic booster can be disposed, comprising:
a) a gastight tank having at least one weakened zone which is designed to be destroyable from a specific pressure inside the tank;
b) a pressurized reactive gas or gas mixture, in particular hydrogen and oxygen in a reactive mixture, optionally together with an inert gas;
c) an energy converter disposed inside the compressed gas tank, wherein the gas or the gas mixture can be activated when electric current is applied to the energy converter.

The energetic booster disposed inside the pressure chamber is provided to boost the expansion of a gas volume inside the pressure chamber. In doing so, the energetic booster can be activated in the same way as the energy converter in the activation device. The basic idea substantially is that the energy converter causes a reactive gas or gas mixture, in particular hydrogen and oxygen in a reactive mixture, to undergo an exothermal reaction so that the pressure wave and energy released by the exothermal reaction destroys the weakened zone of the gas tank. The released gas or gas mixture as well as the combustion products resulting from the reaction in this way additionally increase the pressure inside the pressure chamber.

The energetic booster may be disposed at almost any positions inside the pressure chamber.

In an advantageous embodiment of the invention, plural energetic boosters are provided.

Plural energetic boosters inside the pressure chamber can mutually boost each other when activated and can thus increase the pressure inside the pressure chamber several times.

A capacitor can be connected to plural energetic boosters and can be arranged to apply electric current in parallel or sequentially to plural energy converters.

Therefore, either one or more energy converters can be actuated as required. By applying an electric current in parallel or sequentially to the energy converters, it is possible to react to different situations flexibly in terms of time and energy.

Further, the invention relates to a safety device in a vehicle comprising a gas generator, the safety device including an airbag or a belt tensioner, and the gas generator being provided for filling the airbag or for driving the belt tensioner.

By using an energy converter free from pyrotechnics, an airbag can be filled or a belt tensioner can be driven without the necessity to activate a pyrotechnical propellant inside a vehicle. Consequently, the safety device in the vehicle is free from pyrotechnics, too.

In addition, a synergistic effect results between an activation device that can be actuated solely electrically comprising an energy converter free from pyrotechnics and the further components of the safety device. Advantageously, the activation device is directly connected to the onboard electronics of the vehicle. The onboard electronics thus is capable of actuating the activation device of the gas generator itself so that the gas generator is embedded substantially completely in the onboard electronics of the vehicle. Since the energy converter is operated solely electrically and only resorts to physical measures for expanding the gas volume, it can also interact with the electronic sensor system of the onboard system.

In an advantageous configuration of the invention, the safety device therefore includes a pre-crash sensor system that is arranged to detect an imminent collision with another object, to generate data thereof and to forward the latter to at least one computing unit.

The energy converter is coupled to the pre-crash sensor system of the safety system of the vehicle. Since the energy converter can be actuated variably and repeatably, it is thus possible to selectively control the energy converter by the safety device of the vehicle. The vehicle can rely on the data of the pre-crash sensor system and can selectively actuate the energy converter by means of the generated data.

In an advantageous embodiment, at least one data connection from the computing unit to the pre-crash sensor system is provided, the computing unit being designed to receive data of the imminent collision from the pre-crash sensor system and to evaluate them regarding a trigger or non-trigger scenario.

As a result, this enables the gas generator and the related activation device to be digitalized with the energy converter. Accordingly, the data of the imminent collision can be used to selectively trigger the energy converter and to adjust the trigger behavior of the energy converter depending on the severity of the trigger scenario. Since the energy converter only relies on purely physical measures to heat and expand a gas volume, said purely physical measures can be predicted and calculated almost completely. In combination with a pre-crash sensor system and the pertaining computing unit, consequently an almost complete control over the responsiveness of the activation device and the energy converter is provided.

Furthermore, the invention relates to a method of triggering a safety device in a vehicle, the method comprising the steps of:
a) detecting an imminent collision of the vehicle with a physical object by a pre-crash sensor system,
b) evaluating the imminent collision regarding the presence of a trigger or non-trigger scenario,
c) detecting a trigger scenario,
d) classifying the trigger scenario into different severities,
e) triggering the activation device in the gas generator by discharge of a current pulse by at least one capacitor in at least one energy converter, the computing unit adapting the duration, current intensity and voltage of the current pulse depending on the severity,
f) heating and expanding the compressed gas inside the gas generator, the capacitor optionally discharging further current pulses in the at least one energy converter while the gas expands, and
g) releasing the compressed gas to the environment of the gas generator for filling an airbag or for driving a belt tensioner.

The above-described method enables the activation device with the energy converter free from pyrotechnics to be integrated in a computer-aided safety device in a vehicle for filling an airbag or for driving a belt tensioner. The pre-crash sensor system assesses the severity of a possible collision and then can actuate the activation device with varying degrees of intensity.

Advantageously, the energy converter is repeatedly actuated with variable duration, current intensity and voltage of a current pulse. In particular, in the case of a particularly severe collision, plural current pulses can be transferred to the energy converter so that the energy converter expands the surrounding gas volume several times, whereupon the airbag is filled more quickly as well as remains filled for a longer time.

### BRIEF DESCRIPTION OF THE DRAWINGS

Hereinafter the invention shall be illustrated by way of preferred embodiments with reference to the attached drawings, wherein:

FIG. 1 shows a longitudinal section view of a first embodiment of the gas generator according to the invention;

FIG. 2 shows a longitudinal section view of a second embodiment of the gas generator according to the invention;

FIG. 3 shows a longitudinal section view of a third embodiment of the gas generator according to the invention;

FIG. 4 shows a longitudinal section view of a fourth embodiment of the gas generator according to the invention.

### DESCRIPTION

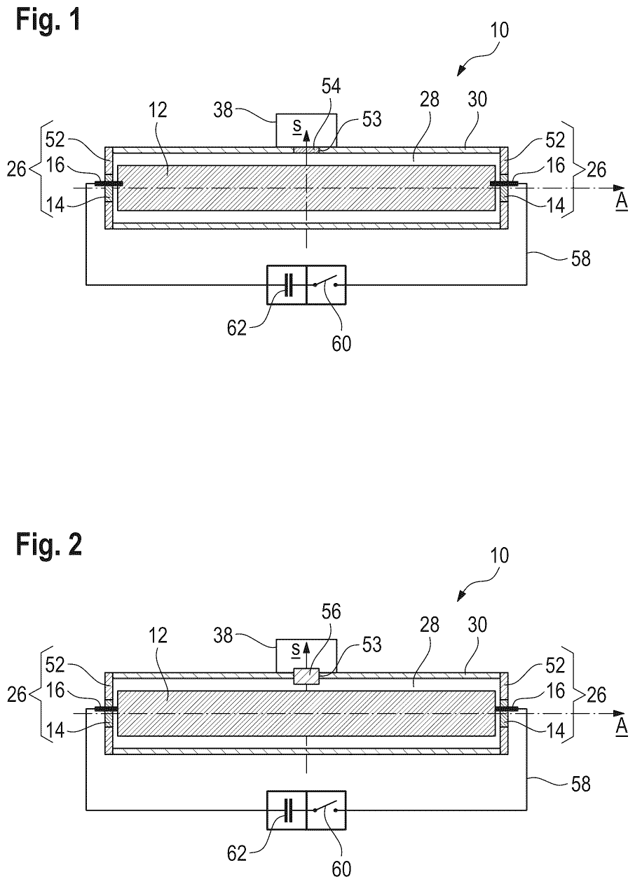

FIG. 1 illustrates a longitudinal section across a gas generator 10 according to the invention.

The gas generator 10 is a tubular gas generator and comprises a central elongate cylindrical pressure chamber 28 having an axial direction A.

The pressure chamber 28 is laterally delimited by a cylindrical outer wall with a cylinder wall 30 in the form of a separate part.

The pressure chamber 28 longitudinally has two ends arranged opposite each other which delimit the pressure chamber longitudinally in the axial direction A. Each of the two ends is formed as a separate activation device 26 and is connected, specifically welded, in a gastight manner to the cylinder wall 30.

Thus, the pressure chamber 28 is delimited in the axial direction A by two activation devices 26 arranged opposite each other and laterally by the cylinder wall 30. Thus, the pressure chamber 28 is closed.

Further, a pressurized gas is stored in the pressure chamber 28. In particular, the pressure chamber 28 is filled with a compressed gas of helium, a helium/argon mixture or a helium/argon/oxygen mixture at a pressure between 240 and 1500 bar.

An activation device 26 comprises each of a cylindrical pressure chamber base 52, a closure element 14 and a pin 16.

The closure element 14 is enclosed proximally in the cylindrical pressure chamber base 52 and is connected thereto in a gastight manner. For example, the closure element 14 can be a gastight metal-glass-packing.

A pin 16 which protrudes through the closure element 14 into the pressure chamber 28 is embedded in the closure element 14. The pin 16 is preferably made of a metallic wire such as copper or stainless steel. The pin 16 can also be a metallic pin or rod, however.

The pins 16 of the two activation devices 16 are connected to each other via a conductor 58 disposed outside the pressure chamber. The conductor 58 is made of a metallic material.

The conductor 58 includes a capacitor 62 and a switch 60. In particular, the switch 60 is designed to close an electric circuit between the two pins 16.

As described in the beginning, the pins 16 protrude into the pressure chamber 28 and are part of the activation devices 26 arranged opposite each other. Thus, also the pins 16 are arranged opposite each other.

An energy converter 12 is disposed inside the pressure chamber 28 and between the two pins 16 arranged opposite each other. The energy converter 12 spatially connects the two pins 16 to each other.

The energy converter can be formed particularly of crosslinked carbon nanotubes based on selectively partially oxidized graphene. The energy converter preferably has at least one of the following properties:
a heating rate of at least 10⁵ K s⁻¹ for a gas or gas mixture at 1 bar;
a volumetric thermal capacity of maximum 5 KJ m⁻³ K⁻¹;
a volumetric surface of minimum 0.01 m² cm⁻³;
a density of less than 100 mg cm⁻³; and/or
a Knudsen number of «1.

When the switch 60 is closed, the energy converter 12, the pins 16 and the conductor 58 form a closed electric circuit.

The energy converter 12 is disposed inside the pressure chamber 28. Accordingly, the energy converter 12 can be arranged and shaped as desired as long as free expansion and circulation of the compressed gas inside the pressure chamber 28 is possible. For example, the energy converter can be present as an accumulation of pellets, as a monolithic block or as a coating arranged on the wall side.

The energy converter 12 is disposed along the axial direction A of the gas generator 10. In particular, the energy converter 12 is disposed continuously along the axial direction A of the gas generator 10. In this way, the energy converter 12 connects the two opposed pins 16 to each other.

The cylinder wall 30 includes a centrally located outflow opening 53.

The outflow opening 53 is closed by a bursting element 54. The bursting element 54 can be designed as a bursting disk or a bursting membrane.

A diffuser 38 is disposed outside the pressure chamber 28 and above the bursting element 54. The diffuser 38 can be connected to the cylinder wall 30.

The diffuser 38 substantially forms a curved cap having lateral escape holes (not shown here) for the compressed gas to be released.

An activation process of the above-described gas generator 10 shall be described in detail as follows.

The electrical energy stored in the capacitor 62 is released by actuating the switch 60. Electric current is applied to the pins 16 arranged opposite each other via the conductors 58. The two pins 16 form a positive pole and a negative pole and ensure electrical contacting of the energy converter 12 disposed in the pressure chamber 28. By applying electric current to the energy converter 12, the energy converter 12 heats and suddenly expands the compressed gas disposed in the pressure chamber 28. The bursting element 54 is designed so that it tears from a certain excess pressure inside the pressure chamber 28. Thus, the compressed gas stored in the pressure chamber 28 can escape from the gas generator 10 through the diffuser 38. Since the diffuser 38 and the bursting element 54 are arranged proximally relative to the cylindrical gas generator 10, the compressed gas flows out along an outflow direction S. The outflow direction S is perpendicular to the axial direction A of the gas generator 10.

FIG. 2 illustrates a longitudinal section view across a second embodiment of the gas generator 10 according to the invention.

The gas generator 10 is substantially identical to the above-described gas generator from FIG. 1. However, the bursting element 54 is in the form of a pressure relief valve 56.

The pressure relief valve 56 closes the outflow opening 53 of the cylinder wall 30. A diffuser 38 is attached to the pressure relief valve 56.

If electric current is applied to the pins 16, the energy converter 12 disposed in the pressure chamber 28 heats and suddenly expands the compressed gas. At a specific excess pressure prevailing inside the pressure chamber 28, the pressure relief valve 56 opens the outflow opening 53. The outflowing compressed gas thus can escape through the diffuser 38.

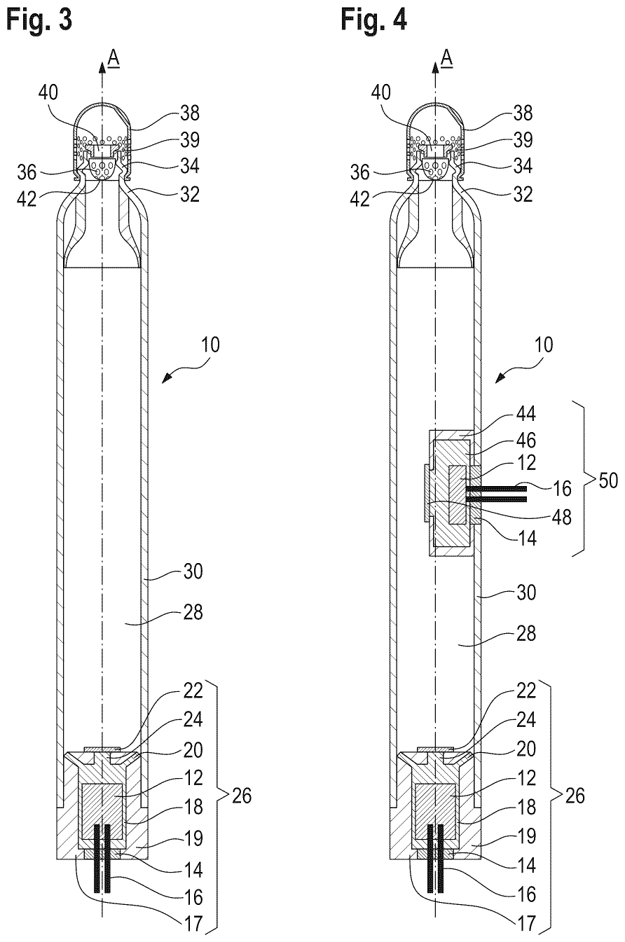

FIG. 3 illustrates another longitudinal section view across a third embodiment of the gas generator 10 according to the invention.

There is shown an elongate tubular gas generator including a central elongate cylindrical pressure chamber 28. The gas generator 10 takes a substantially tubular shape.

In general, the gas generator 10 can be divided into two sections. The first section comprises an activation device 26, whereas the second section comprises a pressure chamber 28.

Hereinafter, the structure of the pressure chamber 28 shall be described in detail.

The pressure chamber is substantially tubular. Thus, the pressure chamber 28 takes an elongated cylindrical shape and has an axial direction A along the gas generator 10.

The pressure chamber 28 is closed and is filled with a compressed gas consisting of inert gas such as helium, argon, a helium/argon mixture or a helium/argon/oxygen mixture at a pressure ranging from 240 to 1500 bar.

Further, the pressure chamber 28 is laterally delimited by a cylindrical outer wall with a cylinder wall 30 formed as a separate part.

At the front, the pressure chamber 28 includes a second opening 42 that is closed by a second bursting element 40. At the opposite front end, the pressure chamber 28 has a first opening 24 that is closed by a first bursting element 22.

The design is preferably such that the bursting pressure for exposing the first opening 24 is higher than the bursting pressure for exposing the second opening 42.

The second bursting element 40 is welded to a front side of the diffuser 38 which thus also serves as a membrane holder. A filter element 36 is disposed in the area of the second opening 42. The filter element 36 particularly covers the second opening 42 completely, wherein the filter element is permeable to the escaping gas and, at the same time, withholds residues still occurring when the gas generator 10 is activated.

In addition, a sleeve-shaped diffuser 38 which is provided with radial outlet openings 39 is welded in the area of the second opening 42. The sleeve-shaped diffuser 38 is attached to the filter element 36, the opening 42 and the second bursting element 40 and covers them completely.

As can be seen from FIG. 3, starting from the first bursting element 22, the cylinder wall 30 is shaped to be uniform and circular-cylindrical and has a constant inner diameter in the axial direction A of the gas generator 10. However, the cylinder wall 30 is tapered in the form of a bottle-neck toward the second bursting element 40. In said tapering section, the surfaces pointing in the axial direction A are designed so that they are inclined toward the second bursting element 40. Said surfaces pointing in the axial direction A are denoted with 32, 34. Shortly ahead of the second bursting element 40, the pressure chamber 28 has a section with a uniform inner diameter.

The second bursting element 40 is arranged proximally from the cylinder wall 30. The second bursting element 40 has a significantly smaller diameter than the first bursting element 22, just as the second opening 42 is significantly smaller than the first opening 24. The cross-sectional area of the first opening 24 is larger by approx. 1.1 to 10 times than that of the second opening 42, preferably larger by approx. 1.3 to 3 times. In the illustrated embodiment, the diameter concretely is about twice as large.

In the following, the structure of the activation device 26 shall be described in detail.

The activation device 26 has an activation chamber 18. The activation chamber 18 is connected to the pressure chamber 28 through the first opening 24.

The first bursting element 22 closes the first opening 24 and thus delimits the activation chamber 18 of the activation device 26. The activation chamber 18 is laterally delimited by a cylindrical outer wall 19 tapering toward the pressure chamber 28 in the axial direction and merging radially into the cylinder wall 30 of the pressure chamber 28. The outer wall 19 is connected, particularly welded, to the cylinder wall 30. The activation chamber 18 is delimited by a chamber base 17 arranged opposite to the first bursting element 22.

In addition, the activation chamber 18 is connected to the pressure chamber 28 via two compensation holes 20 for pressure compensation. In this embodiment, the compensation holes 20 are arranged as passages extending obliquely relative to the cylinder wall 30.

Consequently, also the activation chamber 18 is filled with a compressed gas consisting of inert gas such as helium, argon, a helium/argon mixture or a helium/argon/oxygen mixture at a pressure ranging from 240 to 1500 bar.

In general, the activation chamber 28 is connected to the pressure chamber 28 through a first hole 24 and the two compensation holes 20. However, the compensation holes 20 are many times smaller than the first hole 24 so that they are not involved in an expansion of the gas during a later activation process.

A closure element 14 which is arranged proximally relative to the outer wall 19 is embedded in the chamber base 17. For example, the closure element 14 may be a gastight metal-glass packing.

The closure element 14 additionally constitutes a holder for the two pins 16.

The two pins 16 extend in the axial direction A and are anchored in, specifically connected in a gastight manner to, the closure element 14. In addition, the two pins 16 protrude into the activation chamber 18.

Preferably, the pin 16 is made from a metallic wire such as copper or stainless steel. The pin 16 can also be designed as a metallic pin or rod, however.

The pins 16 of the two activation devices 26 are connected to each other via a conductor 58 (not shown) disposed outside the pressure chamber. The conductor 58 includes a capacitor 62 (not shown) and a switch 60 (not shown). In particular, the switch 60 is designed to close an electrical circuit between the two pins 16.

The two pins 16 enable an energy converter 12 to be electrically connected to a power source so that the energy converter 12 can be electrically released.

The energy converter 12 is disposed inside the activation chamber 18 and connects the two pins 16 to each other.

Additionally, the energy converter 12 can take any shape as long as the gas volume provided in the chamber can freely expand during heating.

As described in the beginning, the gas generator illustrated in FIG. 3 is a shockwave generator. The formation of a shockwave can be described as follows.

When the activation device 26 is activated, the energy converter 12 is actuated, causing the compressed gas surrounding the energy converter to be heated and expanded and the first bursting element 22 to be destroyed. This results in an abrupt pressure difference between the pressure chamber 28 and the activation chamber 18 by which a so-called shockwave is generated. The shockwave propagates in the axial direction A at high speed through the pressure chamber 28 and is bundled in the area of the tapered end. Thus, the second bursting element 40 is destroyed by the shockwave so that the compressed gas escapes from the gas generator.

FIG. 4 illustrates a longitudinal section view across a fourth embodiment of the gas generator 10 according to the invention.

The gas generator 10 shown in this embodiment is substantially identical to the gas generator 10 shown in FIG. 3.

The gas generator 10 of FIG. 4 additionally includes an energetic booster 50, however, that is disposed inside the pressure chamber 28.

Hereinafter, the structure and the arrangement of the energetic booster 50 shall be described in detail.

The pressure chamber 28 includes a tank 44 fastened on the wall side.

The tank 44 delimits a tank chamber 46.

Furthermore, the tank 44 is closed and gastight.

Moreover, the tank 44 is substantially tube-shaped and has an extension along the axial direction A of the gas generator 10. The tank 44 further includes a proximally located weakened zone 48.

The tank 44 is welded to the cylinder wall 30 and includes a closure element 14 which is equally connected to the cylinder wall 30.

The closure element 14 accommodates two pins 16 protruding into the tank chamber 46. The two pins 16 are electrically connected to each other outside the pressure chamber 28 and the tank chamber 46 via an electrical circuit not shown in detail.

Inside the tank chamber 46, the two pins 16 contact an energy converter 12.

The energy converter 12 can be arranged and shaped as desired inside the tank chamber 46 as long as a compressed gas stored in the tank chamber 46 can expand freely during heating.

A gas or a gas mixture maintaining hydrogen and oxygen in a reactive mixture is provided inside the tank 44.

The energetic booster 50 is arranged to activate an energy converter 12 when electric current is applied to the two pins 16. When electric current is applied to the energy converter 12, the latter can heat the mixture of hydrogen and oxygen provided inside the tank 44 so that the two components react with each other in an exothermal reaction. The energy released from the reaction destroys the weakened zone 48 of the tank 44. Therefore, the gas can flow out of the tank 44 and can help expand the compressed gas stored in the pressure chamber 28. For example, a shockwave generated inside the pressure chamber 28 can be intensified. However, it is also imaginable that the energetic booster is ignited after propagation of the shockwave in terms of time to allow the compressed gas to flow out of the gas generator 10 longer in time.

1. A gas generator, specifically for a safety device in a vehicle, comprising an activation device which comprises an energy converter, wherein
the energy converter is surrounded by gas and is free from pyrotechnical materials, and wherein the energy converter is designed, when electric current is applied, to convert electrical energy directly to thermal energy and to release the same, the released thermal energy suddenly heating and expanding the gas surrounding the energy converter.

2. The gas generator according to claim 1, wherein the energy converter has an open-porous structure based on crosslinked carbon nanotubes, the carbon nanotubes consisting of graphene and/or partially oxidized graphene.

3. The gas generator according to claim 1, wherein the energy converter fulfils at least one of the following properties:
a heating rate of at least 10⁵ K s⁻¹ for a gas or gas mixture at 1 bar;
a volumetric thermal capacity ranging from 0.5 KJ m⁻³ K⁻¹ to 5 KJ m⁻³ K⁻¹;
a volumetric surface ranging from 0.01 m² cm⁻³ to 1 m² cm⁻³;
a density of less than 100 mg cm⁻³; and/or
a Knudsen number of «1.

4. The gas generator according to claim 1, wherein a capacitor communicated with a power source is associated with the activation device, wherein
the capacitor has an electrical contact to the energy converter and is arranged to apply electric current to the energy converter.

5. The gas generator according to claim 4, wherein the electric current takes the shape of a current pulse, wherein the duration, the current intensity and the voltage of the current pulse can be adjusted.

6. The gas generator according to claim 1, wherein the activation device is disposed inside a pressure chamber and the gas surrounding the energy converter is a compressed gas, wherein
the pressure chamber includes an outflow opening closed by a pressure relief valve, wherein
the pressure relief valve opens the outflow opening from a specific excess pressure inside the pressure chamber.

7. The gas generator according to claim 6, wherein the pressure relief valve is a bursting element.

8. The gas generator according to claim 1, wherein a pressure chamber filled with compressed gas is provided with a first bursting element, wherein
the first bursting element closes a first hole in the axial direction of the pressure chamber, wherein
the pressure chamber includes a second bursting element opposite to the first bursting element which closes a second hole in the axial direction of the pressure chamber, wherein
the activation device is disposed outside the pressure chamber and close to the first bursting element, and wherein,
by applying electric current to the energy converter, the first bursting element is destroyed and a shockwave is formed which is sufficient to open the second bursting element.

9. The gas generator according to claim 8, wherein the activation device and the pressure chamber are connected to each other through at least one compensation hole for pressure compensation.

10. The gas generator according to claim 6, wherein the energy converter is formed as a pressure sensor for monitoring the gas pressure.

11. The gas generator according to claim 1, wherein the gas or gas mixture surrounding the energy converter contains an inert gas, specifically argon.

12. The gas generator according to claim 1, wherein the gas or gas mixture surrounding the energy converter contains hydrogen and oxygen in a reactive mixture.

13. The gas generator according to claim 6, wherein at least one energetic booster is disposed inside the pressure chamber, comprising:
a gastight tank having at least one weakened zone that is designed so that it can be destroyed from a specific pressure inside the tank;
a pressurized reactive gas or gas mixture, specifically argon as well as hydrogen and oxygen in a reactive mixture;
an energy converter disposed inside the tank, wherein the gas or gas mixture can be activated when electric current is applied to the energy converter.

14. The gas generator according to claim 13, wherein plural energetic boosters are provided.

15. The gas generator according to claim 14, wherein a capacitor is connected to plural energetic boosters and is arranged to apply electric current to plural energy converters in parallel or sequentially.

16. A safety device in a vehicle comprising a gas generator according to claim 1, wherein the safety device comprises an airbag or a belt tensioner, the gas generator being provided to fill the airbag or to drive the belt tensioner.

17. The safety device in a vehicle according to claim 16, wherein the safety device includes a pre-crash sensor system arranged to detect an imminent collision with another object, to generate data thereof and to forward them to at least one computing unit.

18. The safety device in a vehicle according to claim 17, wherein there is provided at least one data connection from the computing unit to the pre-crash sensor system, the computing unit being configured to receive data of the imminent collision from the pre-crash sensor system and to evaluate them regarding a trigger or non-trigger scenario.

19. A method of triggering a safety device according to claim in a vehicle, wherein the method comprises the steps of:
a) detecting an imminent collision of the vehicle with a physical object by a pre-crash sensor system,
b) assessing the imminent collision regarding the presence of a trigger or non-trigger scenario,
c) detecting a trigger scenario,
d) classifying the trigger scenario into different severities,
e) triggering the activation device in the gas generator by discharging a current pulse by at least one capacitor into at least one energy converter, wherein the computing unit adapts the duration, the current intensity and the voltage of the current pulse in response to the severity,
f) heating and expanding the compressed gas in the gas generator, wherein the capacitor optionally discharges further current pulses into the at least one energy converter while the gas expands, and
releasing the compressed gas to the environment of the gas generator for filling an airbag or for driving a belt tensioner.
